(19) United States
(12) Patent Application Publication
(10) Pub. No.: US 2026/0077770 A1
(43) Pub. Date: Mar. 19, 2026

(54) SYSTEM AND METHOD FOR GENERATING DRIVING DATA

(71) Applicant: HERE Global B.V., Eindhoven (NL)

(72) Inventor: Priyank SAMEER, Mumbai (IN)

(21) Appl. No.: 18/888,906

(22) Filed: Sep. 18, 2024

(51) Int. Cl. B60W 40/08; G06V 20/56; G06V 20/58

(52) U.S. Cl. CPC B60W 40/08; G06V 20/58; G06V 20/588; B60W 2556/10

(57) ABSTRACT

Embodiments of the present disclosure disclose a system for generating driving data for navigation assistance during vehicle transition. The system obtains historical driving data associated with a first vehicle and determines second LOS data associated with a second LOS of a second vehicle. The historical driving data comprises first line of sight (LOS) data. The second LOS comprises a plurality of objects. The system determines an overlapping area based on the first LOS data and the second LOS data. The overlapping area comprises one or more objects from the plurality of objects. The system generates driving data for the second vehicle based on the one or more objects in the overlapping area.

### TECHNOLOGICAL FIELD

The present disclosure generally relates to generating navigation instructions, and more particularly relates to systems and methods for generating driving data for navigation assistance during vehicle transition.

### BACKGROUND

In recent years, consumers are changing their vehicles more frequently than before. For example, a combination of technological advancements, changing preferences, financial incentives, and environmental considerations contributes to consumers' tendency to change their vehicles more frequently than in the past. This trend is likely to continue as automotive technology continues to evolve, and consumer preferences and lifestyle needs continue to shift.

Typically, consumers transition from small vehicles to bigger vehicles, such as SUVs, luxury vehicles, recreational vehicles (RVs), etc. However, the transition between different vehicles, specifically, from a small vehicle to a larger vehicle, whether due to rental, purchase, or temporary usage, presents several challenges for users. One significant challenge arises from the variation in size, dimensions, and configurations of different vehicles, leading to difficulties in adapting to the new driving environment.

A primary concern during vehicle transition is alteration in a user’s or a driver's line of sight. Each vehicle possesses unique design features, such as varying heights, widths, and window placements, resulting in differences in the driver's visual perspective. This disparity in line of sight may compromise driving safety and efficiency, potentially leading to accidents or discomfort for the driver.

Additionally, changes in vehicle size and layout often necessitate a period of adjustment for drivers to familiarize themselves with the new driving dynamics, controls, and spatial awareness. This adjustment phase may contribute to increased stress and apprehension, particularly in situations where the transition must occur swiftly, such as during rentals or emergency vehicle replacements.

To this end, it becomes crucial to reduce the period of adjustment for drivers and assist drivers during the transition for ensuring safety and improving experience of user while driving a new vehicle.

### BRIEF SUMMARY OF SOME EXAMPLE EMBODIMENTS

In order to solve the foregoing problem, the present disclosure may provide a system, a method and a computer programmable product that generates driving data for navigation assistance during vehicle transition.

The embodiments of the present disclosure are based on an understanding that when a user or a driver change from one vehicle to a new vehicle of a different vehicle type, the driver may have to familiarize themselves with the new vehicle. Further, an adjustment period of the driver for transitioning from an old type of vehicle to a new type of vehicle may arise as every vehicle may have their unique construct and characteristics. The adjustment period is more prominent for users having less experience in driving or when a change from the old type of vehicle that is recurrently used to the new type of vehicle is drastic. To this end, the user may be slightly more susceptible to accidents when changing or driving a new vehicle.

A system, a method and a computer programmable product are provided for implementing a process for generating driving data for navigation assistance during vehicle transition when transitioning from a first vehicle to a second vehicle.

In one aspect, a system for generating driving data is disclosed. The system comprises a memory configured to store computer executable instructions and one or more processors configured to execute the instructions to obtain historical driving data associated with a first vehicle. The historical driving data comprises at least first line of sight (LOS) data. The one or more processors are configured to determine second LOS data associated with a second LOS of a second vehicle. The second LOS comprises a plurality of objects. The one or more processors are configured to determine an overlapping area based on the first LOS data and the second LOS data. The overlapping area comprises one or more objects from the plurality of objects. The one or more processors are configured to generate driving data for the second vehicle based on the one or more objects in the overlapping area.

In additional system embodiments, the second LOS data comprises object data associated with the plurality of objects within the second LOS of the second vehicle. The one or more processors are further configured to identify an object from the one of more objects in the second LOS lying completely within the overlapping area, based on the object data, and generate the driving data for the second vehicle based on the identified object.

In additional system embodiments, the one or more processors are further configured to obtain object preference data associated with a user and generate the driving data for the second vehicle based at least in part on the object preference data. In an example, the user is associated with the first vehicle and the second vehicle.

In additional system embodiments, the one or more processors are further configured to obtain map data associated with the second LOS, determine lane view data associated with one or more lanes within the second LOS based on the second LOS data and the map data, identify a lane from the one or more lanes lying within the overlapping area, and generate the driving data for the second vehicle based on the identified lane.

In additional system embodiments, the first vehicle is a recurrently used vehicle associated with a user and the second vehicle is a new vehicle associated with the user.

In additional system embodiments, the historical driving data associated with the first vehicle further includes at least one of: vehicle characteristic data, sensor data, driving characteristic data associated with a user of the first vehicle, and historical adaptation data associated with the user.

In additional system embodiments, the one or more processors are further configured to determine updated driving characteristic data of the user based on the historical driving data and the second LOS data, generate the driving data for the second vehicle based on the updated driving characteristics of the user.

In additional system embodiments, the one or more processors are further configured to determine a compatibility score for the user based on the historical driving data associated with the first vehicle and the second LOS data and generate a recommendation of one or more vehicles associated with one or more vehicle types based on the compatibility score.

In additional system embodiments, the historical driving data comprises at least one of: seat adjustment data, height data associated with a driver, steering adjustment data, outer rear view mirror adjustment data, and inner rear view mirror adjustment data.

In additional system embodiments, the one or more processors are further configured to execute the instructions to generate a simulation environment based on the overlapping area and the second LOS data and provide the driving data for controlling navigation of a simulation of the second vehicle within the simulation environment.

In another aspect, a method for generating driving data is disclosed. The method comprises obtaining historical driving data associated with a first vehicle. The historical driving data comprises at least first line of sight (LOS) data. The method further comprises determining second LOS data associated with a second LOS of a second vehicle. The second LOS comprises a plurality of objects. The method further comprises determining an overlapping area based on the first LOS data and the second LOS data. The overlapping area comprises one or more objects from the plurality of objects. The method further comprises generating driving data for the second vehicle based on the one or more objects in the overlapping area.

In yet another aspect, a computer program product for generating driving data for navigation assistance during vehicle transition is disclosed. The computer program product comprises a non-transitory computer readable medium having stored thereon computer executable instructions which when executed by at least one processor, cause the processor to carry out operations. The operations comprise obtaining historical driving data associated with a first vehicle. The historical driving data comprises at least first line of sight (LOS) data. The operations comprise determining second LOS data associated with a second LOS of a second vehicle. The second LOS comprises a plurality of objects. The operations comprise determining an overlapping area based on the first LOS data and the second LOS data. The overlapping area comprises one or more objects from the plurality of objects. The operations comprise generating driving data for the second vehicle based on the one or more objects in the overlapping area.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram of a network environment where a system for generating driving data for navigation assistance during vehicle transition is implemented, in accordance with an embodiment of the present disclosure;

FIG. 2 illustrates a block diagram of the system of FIG. 1 for generating driving data for navigation assistance during vehicle transition, in accordance with an example embodiment of the present disclosure;

FIG. 3 illustrates an example LOS in which the generated driving data is used, in accordance with an example embodiment of the present disclosure; and

FIG. 4 illustrates a flowchart of a method for generating driving data for navigation assistance during vehicle transition, in accordance with an example embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown.

### DEFINITIONS

The term “vehicle” may refer to an autonomous, semi-autonomous or manual automotive vehicle that may use one or more motors for propulsion on or above ground surface. In an example, vehicle refers to any device or apparatus capable of transporting goods or passengers over land, water, or air. The vehicle may also extend to encompass various components, systems, and accessories associated with transportation devices, such as propulsion systems, control mechanisms, navigation systems, safety features, energy storage devices, and communication systems. Generally, a vehicle may encompass a wide range of transportation means, including but not limited to, land vehicles, aircraft, and watercraft. While the embodiments of the present disclosure are described with regard to the vehicle being a land vehicle, however, this should not be construed as a limitation. Implementation of the embodiments of the present disclosure to other types of vehicles may be apparent to a person skilled in the art.

The term “line of sight (LOS)” may refer to unobstructed visual field or field of view that a driver has while operating a vehicle. LOS refers to the ability of the driver to see clearly in front, behind, and/or to the sides of the vehicle without any obstacles blocking their view. Pursuant to present disclosure, the LOS is referred with regard to visual field in front of the driver in the vehicle. Subsequently, LOS data indicates data relating to the visual field in front of the driver in the vehicle.

The term “objects” refers to all types of items and/or material things that may be seen and touched. In accordance with the present disclosure, objects refer to items, such as material or person, that may be present in a LOS of the driver of the vehicle. Objects in the LOS of a vehicle refer to any physical entities or obstacles that may be seen by the driver while operating the vehicle. Examples of the objects may include, but are not limited to, other vehicle(s) (such as cars, trucks, motorcycles, bicycles, buses, etc.), pedestrians, cyclists, obstacles (such as, debris, potholes, road construction signs, barriers, and parked vehicles, etc.), traffic signals, traffic signs (such as, stop signs, yield signs, speed limit signs, and other regulatory signs), and road infrastructure (such as, roads, lane markings, curbs, medians, guardrails, dividers, etc.).

The term “historical driving data” may refer to various types of information collected from a vehicle's operation and performance. For example, driving data may also indicate how a vehicle has been operated by a driver or a user. The driving data may be generated by onboard sensors, vehicle systems, and external sources. In certain cases, the driving data may include, but is not limited to, vehicle speed (such as, current speed, average speed, and maximum speed), acceleration and deceleration data, distance traveled, fuel consumption (such as, fuel usage, fuel efficiency, and fuel economy, fuel consumption rate and mileage), engine performance data (such as, revolutions per minute (RPM), engine temperature, oil pressure, and engine diagnostic codes), braking behavior data (such as, brake application intensity, brake application duration, brake application frequency, instances of hard braking or abrupt stops, etc.), vehicle locations (such as, current location, route taken, and historical travel patterns), driver behavior data (such as steering inputs, lane changes, turn signals usage, seatbelt usage, and adherence to speed limits and traffic rules), vehicle diagnostics (such as error codes, warning messages, and system malfunctions), safety system activation data (such as, airbag deployment, collision avoidance interventions, and stability control activations), and telematics data (such as, vehicle tracking, remote diagnostics, remote vehicle monitoring, and driver behavior analysis).

In accordance with the present disclosure, the historical driving data may correspond to driving data associated with a first vehicle of a user. For example, the first vehicle could be any type of vehicle that the user currently owns, leases, or operates recurrently or on a regular basis, such as a car, truck, SUV, motorcycle, or any other mode of transportation. Subsequently, during operation of the first vehicle by the user, the historical driving data associated with the first vehicle may be collected. In an example, onboard diagnostic (OBD) systems, sensors, GPS tracking devices, or telematics units onboard the first vehicle may collect, store, and transmit the historical driving data.

Further, the term “new driving data” may correspond to driving data determined by the system described in the present disclosure. Such driving data may correspond to a second vehicle that may be a new or a different vehicle that the user may transition to or acquire. The second vehicle may be a new vehicle that the user has recently acquired, or plans to purchase, lease, or acquire in the future to replace their current vehicle, i.e., the first vehicle, or to supplement their transportation needs. The second vehicle may offer different features, capabilities, or performance characteristics compared to the first vehicle.

### END OF DEFINITIONS

When a user or a driver change from one type of vehicle to another, for example, switching from a Sedan-type vehicle to a Hatchback, SUV, or Truck, a driving style of the user may get affected at least temporarily. In particular, the user may find themselves adjusting to a new or different vehicle, namely, a second vehicle, that they start driving. This adjustment period is common because each type of vehicle has a unique construct, characteristics, and size. However, the adjustment period may be prolonged for certain users owing to the lack of driving expertise of the users.

Typically, the user may manually learn to drive another type of vehicle or the second vehicle after the vehicle transition or during the adjustment period. The vehicle transition may require adjustments in driving techniques, spatial awareness, and overall vehicle handling capabilities. To this end, during the adaptation period, the user may be at a greater risk of accidents due to lack of experience with the second vehicle.

Various embodiments are provided herein for generating driving data for navigation assistance during vehicle transition, such that any risks or safety concerns during the adaptation period of the vehicle transition are minimized. The driving data is generated such that the user is able to reduce the adaptation period. Moreover, the driving data helps the user to adapt to a vehicle size of the second vehicle.

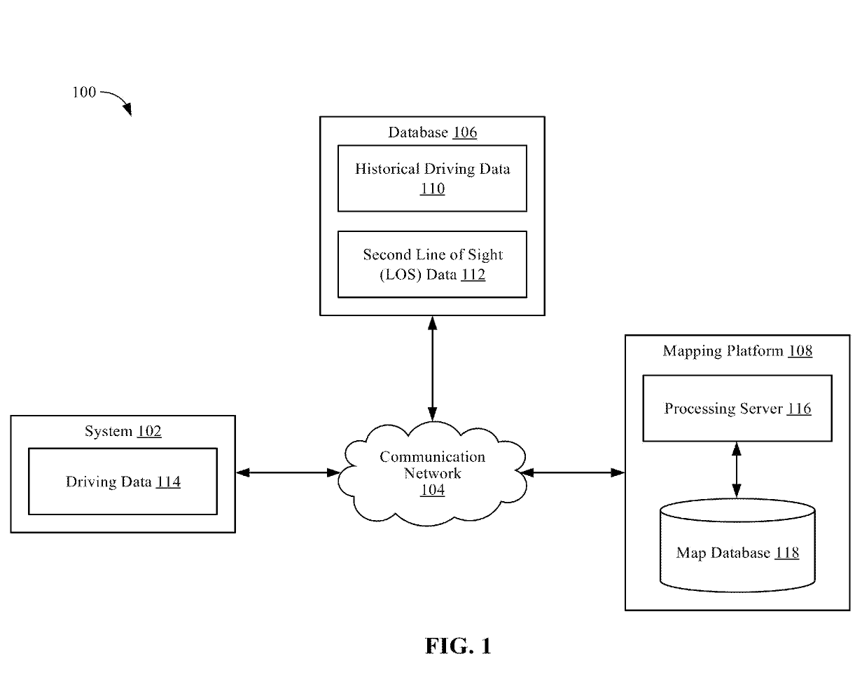

FIG. 1 illustrates a block diagram 100 of a network environment comprising a system 102 implemented for generating driving data for navigation assistance during vehicle transition, in accordance with an example embodiment. In an example, a user may want to transition from one type of vehicle to another type of vehicle. For example, the user may want to transition from a first vehicle type of a first vehicle to a second vehicle type of a second vehicle. In an example, the first vehicle type may be hatchback cars while the second vehicle type may be sports utility vehicles (SUVs). In another example, the first vehicle type may be SUVs while the second vehicle type may be a sports car, such as a racing or a rally car.

Embodiments of the present disclosure provide techniques to reduce an adaptation time period while transitioning from the first vehicle type of the first vehicle to the second vehicle type of the second vehicle. The present disclosure provides techniques to reduce a learning curve of the user for acquiring necessary skills to drive the second vehicle safely and expectantly.

In an example, the system 102 may be coupled with a database 106 and/or a mapping platform 108, via a communication network 104. In an embodiment, the system 102 may be coupled to one or more communication interfaces, for example, as a part of a routing system, a navigation app, and the like.

All the components in the block diagram 100 may be coupled directly or indirectly to the communication network 104. The components described in the block diagram 100 may be further broken down into more than one component and/or combined together in any suitable arrangement. Further, one or more components may be rearranged, changed, added, and/or removed. In an example embodiment, the system 102 may be a processing server 116 of the mapping platform 108 and therefore may be co-located with or within the mapping platform 108. In accordance with an embodiment, the database 106 may be a map database 118 of the mapping platform 108 and therefore may be co-located with or within the mapping platform 108. The database 106 may be configured to receive, store, and transmit data that may be collected from vehicles or from a database associated with a user who is transitioning from the first vehicle to the second vehicle. The system 102 may comprise suitable logic, circuitry, and interfaces that may be configured to provide driving data 114 to the for navigation assistance during vehicle transition.

In operation, the system 102 is configured to obtain historical driving data 110 associated with the first vehicle. In an example, the historical driving data 110 comprises at least first line of sight (LOS) data. The historical driving data 110 pertains to information collected from the first vehicle while the first vehicle was being driven by the user. The historical driving data 110 may include various metrics associated with the first vehicle as well as various metrics associated with how the user drove the first vehicle. The historical driving data 110 may include, for example, speed data, acceleration data, braking pattern data, GPS location data, engine performance data, fuel consumption data, etc.

In particular, the historical driving data 110 includes the first LOS data associated with the first vehicle. The first LOS data may indicate information related to visibility available to the user from their position, i.e., drivers’ seat, within the first vehicle. In other words, the first LOS data may indicate information associated with a first LOS of the first vehicle. The first LOS may indicate an area visible to the user in front of him and/or through the sideview and/or rear view mirrors. In an example, the first LOS data may be dependent on design characteristics of the first vehicle, such as a length of a windscreen, a width of the windscreen, pillar placement, side mirror positioning, rear view mirror positioning, height of the first vehicle, height of driver’s seat, placement of driver’s seat, inclination of driver’s seat, etc.

For example, the first LOS data may indicate the ability of the user to see other objects, such as other vehicles, pedestrians, obstacles, and road signs within the first LOS along their intended path of travel when driving the first vehicle. In an example, the first LOS data may also indicate blind spots when driving the first vehicle. In another example, the first LOS data may also indicate information relating to adjustments, positioning, or orientation of side mirror(s) and/or rear view mirror(s) of the first vehicle. In yet another example, the first LOS data may also indicate information relating to adjustments, positioning, or inclination of a driver’s seat and/or steering of the first vehicle that is operated by the user or has been operated by the user previously. In an example, the first LOS data may be determined based on sensor data received from sensors of the first vehicle, vehicle specifications or characteristics of the first vehicle, and/or data obtained from a third-party website or database associated with the first vehicle.

Further, the system 102 is configured to determine second LOS data 112 associated with a second LOS of the second vehicle. In an example, the second LOS data 112 may indicate visibility within the second LOS that may be available to the user when driving the second vehicle. As may be understood, the second LOS data 112 may be dependent on design characteristics of the second vehicle, such as a length of a windscreen, a width of the windscreen, pillar placement, sideview mirror positioning, rear view mirror positioning, height of the second vehicle, height of driver’s seat, placement of driver’s seat, inclination of driver’s seat, etc. of the second vehicle.

The second LOS may include an area that is visible to a driver of the second vehicle at a given time from the driver’s seat. For example, the second LOS data 112 may also indicate blind spots when driving the second vehicle; information relating to adjustments, positioning, or orientation of side mirror(s) and/or rear view mirror(s) of the second vehicle; and information relating to adjustments, height, positioning, or inclination of a driver’s seat and/or steering of the second vehicle.

In an example, the second LOS comprises a plurality of objects. The second LOS of the second vehicle refers to an extent of visible area around the second vehicle that the user may observe while seated in the driver's position. In an example, the second LOS may include objects that the user may see directly, such as through the windshield and windows of the second vehicle. The second LOS may also include objects that the user may see indirectly, such as through the use of sideview or rear view mirrors and other visual aids of the second vehicle.

Further, the plurality of objects may be elements or entities present within the second LOS of the second vehicle. Examples of the objects may include, but are not limited to, other vehicles (such as cars, trucks, motorcycles, bicycles, and any other vehicles sharing the road with the second vehicle), pedestrians (such as people walking or crossing within the field of view), road signs and signals (such as, traffic signs, signals and road markings providing information associated with speed limits, lane usage, upcoming turns, and other regulations), obstacles (such as, objects, potholes, road construction barriers, fallen branches, debris from accidents, etc.), and infrastructure (such as buildings, trees, bridges, overpasses, and other structures along roadside). For example, based on the second LOS data 112 of the second vehicle, the plurality of objects in the field of view or the second LOS of the second vehicle are identified.

The system 102 is configured to determine an overlap area based on the first LOS data and the second LOS data 112. The overlapping area comprises one or more objects from the plurality of objects. The overlapping area refers to a region where the first LOS and the second LOS intersect or coincide. The first LOS may indicate an area visible through the driver’s seat of the first vehicle. The second LOS may indicate an area visible through the driver’s seat of the second vehicle. Subsequently, the overlapping area may correspond to a space or an area of a line of sight or field of view that overlaps or that is visible through the driver’s seat of the first vehicle as well as the driver’s seat of the second vehicle, if both are placed at a same location. In other words, the overlapping area may define a common area between the area of the first LOS and the area of the second LOS. In an example, the overlapping area may completely lie within the second LOS. In another example, the overlapping area may be partially covered by the second LOS.

Further, the overlapping area includes one or more objects from the plurality of objects in the second LOS. The one or more objects may partially or completely lie in the overlapping area. In certain cases, the system 102 may determine a level of overlap of the object within the first LOS of the first vehicle and the second LOS of the second vehicle. In an example, an object lying in the overlapping area may have a degree of overlap or intersection of a predicted bounding box or a bounding region around the object between the first LOS and the second LOS.

Further, the system 102 is configured to generate driving data 114 for the second vehicle based on the one or more objects in the overlapping area. In particular, the driving data 114 may be provided to the user to enable the user to drive the second vehicle in a more efficient manner. In an example, the driving data 114 may include navigation instructions to assist the user in transitioning from the first vehicle to the second vehicle. For example, the navigation instructions of the driving data 114 are based on the one or more objects from the plurality of objects lying within the overlap area, i.e., the one or more objects that may lie within the first LOS as well as the second LOS. In this manner, the driving data 114 is used to improve transition or driving of the second vehicle using the overlapping area between the first LOS and the second LOS.

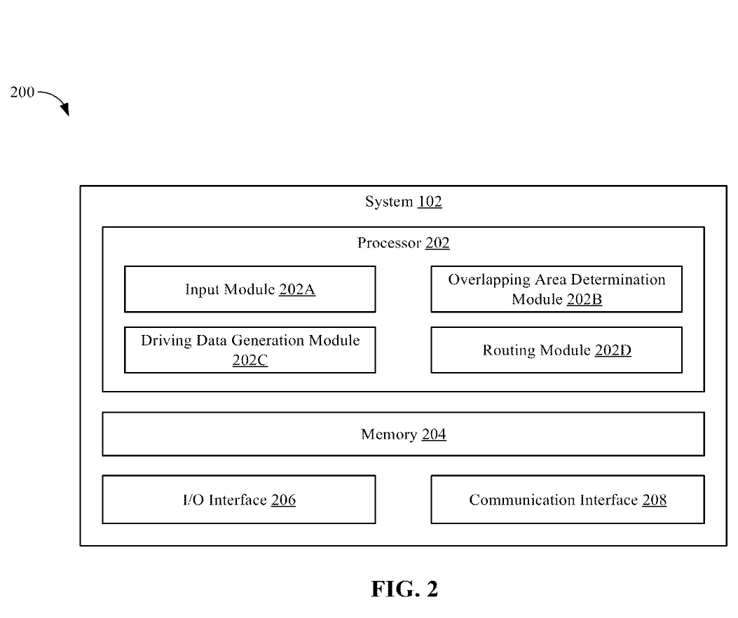

FIG. 2 illustrates an exemplary block diagram 200 of the system 102, in accordance with one or more example embodiments. FIG. 2 is explained in conjunction with FIG. 1.

The system 102 may include one or more processors (referred to as a processor 202, hereinafter), a non-transitory memory (referred to as a memory 204, hereinafter), an input/output (I/O) interface 206, and a communication interface 208. The processor 202 may further include an input module 202A, an overlapping area determination module 202B, a driving data generation module 202C, and a routing module 202D. The memory 204 may further include the historical driving data 110 and second LOS data 112. The memory 204 may also store the driving data 114 that may be generated by the system 102 or the processor 202 during its operation.

The processor 202 may be connected to the memory 204, the I/O interface 206, and the communication interface 208 through one or more wired or wireless connections. Although in FIG. 2 it is shown that the system 102 includes the processor 202, the memory 204, the I/O interface 206, and the communication interface 208, however, the disclosure may not be so limiting and the system 102 may include fewer or more components to perform the same or other functions of the system 102.

The processor 202 of the system 102 may be configured to perform one or more operations associated with generating the driving data 114 for navigation assistance during vehicle transition. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various operations in accordance with embodiments of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein. In an embodiment, memory 204 may be configured to store the historical driving data 110, the second LOS data 112, and the driving data 114, among other data generated during execution of the operations or instruction by the processor 202 for generating the driving data 114.

In some example embodiments, the I/O interface 206 may communicate with the system 102 and display and input and/or output devices, such as the keyboard and mouse of the system 102. As such, the I/O interface 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O interface elements such as the display and, in some embodiments, a plurality of speakers, a ringer, one or more microphones and/or the like. The processor 202 and/or I/O interface 206 circuitry including the processor 202 may be configured to control one or more operations of one or more I/O interface elements through computer program instructions (for example, software and/or firmware) stored on the memory 204 accessible to the processor 202.

The communication interface 208 may include the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

The communication interface 208 of the system 102 may be used to access a communication network. The communication network may include a communication medium through which the system 102 and, for example, the database 106 and the mapping platform 108, may communicate with each other. The communication network may be one of a wired connection or a wireless connection. Examples of the communication network may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), a device to device communication, cellular communication protocols, and Bluetooth (BT) communication protocols.

In one embodiment, the processor 202 may include the input module 202A. The input module 202A may be configured to receive or obtain input data. In an example, the input data may be received from, for example, the database 106, the map database 118 and/or other databases associated with the system 102, a user of the system 102, one or more sensors of vehicles, a navigation or delivery operation service provider, etc. The input data may include the historical driving data 110 relating to a first vehicle, and the second LOS data 112 relating to a second vehicle.

In an example, the historical driving data 110 may include first LOS data relating to the first vehicle. The first LOS data may indicate visible area for the user or a driver of the first vehicle. In an example, the first LOS data associated with the first vehicle may indicate visibility available to the user or driver from their position (i.e., driver’s seat) within the first vehicle. For example, the first LOS data may encompass a range of vision that the user may have, such as through the windshield, the windows, the sideview mirrors, the rear view mirror, and other visual aids of the first vehicle. In an example, the first vehicle is a recurrently used vehicle associated with a user and the second vehicle is a new vehicle associated with the user. The user may have to transition from the first vehicle that they may be currently using to the second vehicle that may be newly acquired.

In another example, the historical driving data 110 may also include vehicle characteristic data relating to the first vehicle, sensor data relating to the first vehicle, driving characteristic data associated with the user of the first vehicle, and historical adaptation data associated with the user. For example, the vehicle characteristic data may include vehicle specifications (such as, make and model, year of manufacture, vehicle identification number (VIN), body type (e.g. sedan, SUV, truck, etc.), engine type and displacement, transmission type (e.g. automatic, manual CVT, etc.), fuel type (e.g. gasoline, diesel, electric, hybrid, etc.), weight dimensions, safety features), performance attributes (such as, maximum speed, acceleration, braking distance, fuel efficiency or mileage, electric range (for electric and hybrid vehicles), towing capacity (for trucks and SUVs), payload capacity (for trucks and vans), etc.) of the first vehicle, and other features of the first vehicle relating to, for example, design, maintenance, safety, comfort, assistance and emissions. The sensor data relating to the first vehicle may be measured from sensors, such as engine sensors, vehicle dynamic sensors, safety sensors, environmental sensors, positioning sensors, and fuel and emission sensors, of the first vehicle. For example, the sensor data may include measurements taken during operation of the first vehicle relating to, but not limited to, acceleration, temperature, wheel rotational speed, yaw rate, mass flow rate, oxygen rate, throttle input, coolant temperature, angular velocity and orientation changes, temperature data, rain data, humidity data, location, speed, heading, obstacles, and collisions. Further, the driving characteristic data associated with the user of the first vehicle may include, but is not limited to, speed, acceleration and deceleration rate, lane change behavior, steering behavior, traffic violations, use of signals (such as turn signals, hazard lights and other signaling devices in the first vehicle), biometrics (such as heart rate, eye movement, and facial expressions), vehicle usage pattern (such as frequency and duration of trips, time spent driving, and typical routes taken), and contextual information (such as, time of day, location, road type, and presence of pedestrians or cyclists). Further, the historical adaptation data associated with the user may indicate a time taken by the user to become accustomed to a new vehicle (such as the first vehicle) after transitioning from their previous vehicle (such as a vehicle used before the first vehicle), as well as type of the previous vehicle and the new vehicle.

In an example, the historical driving data 110 may further include seat adjustment data, height data associated with a user, steering adjustment data, sideview mirror adjustment data, and rear view mirror adjustment data. For example, the seat adjustment data may be associated with a height of a driver’s seat of the first vehicle, a position of the driver’s seat, pitching angle of the driver’s seat, an angle or incline or recline of a backrest of the driver’s seat, a position of the backrest, a position of a headrest of the driver’s seat, and lumbar support adjustment of the driver’s seat. Further, the height data of the user may indicate height, such as in feet, centimeters (cm), or inches, of the user of the first vehicle. The steering adjustment data may be associated with tilt or height of a steering wheel of the first vehicle, and telescopic adjustment or depth of the steering wheel. Further, the sideview mirror adjustment data is associated with a viewing angle of sideview mirrors of the first vehicle; and the rear view mirror adjustment data is associated with a viewing angle of a rear view mirror of the first vehicle. The seat adjustment data, the height data, the steering adjustment data, the outer rear view mirror adjustment data, and the inner rear view mirror adjustment data may be determined based on sensor data collected from the first vehicle when the user may be driving the first vehicle or user input from the user of the first vehicle.

The input module 202A may also obtain, receive, or determine the second LOS data 112. The second LOS data 112 may indicate visible area or visibility available, i.e., second LOS, for the user or a driver from their position (i.e., driver’s seat) within the second vehicle. For example, the second LOS data 112 may also encompass a range of vision that the user may have, such as through the windshield, the windows, the sideview mirrors, the rear view mirror, and other visual aids of the second vehicle.

In an example, the second LOS comprises a plurality of objects. These objects may be present in a visible range from the driver’s seat of the second vehicle. In an example, the second LOS may indicate or relate to a surrounding environment, i.e., a field of view, through the windshield of the second vehicle. The second LOS data may include object data associated with the plurality of objects present within the field of view of the second vehicle. These objects may include, for example, other vehicles, pedestrians, obstacles, road signs, traffic signals, billboards, dividers, etc. In an example, the second LOS data may be in form of an image, a sequence of images, or a video. Further, the object data for an object may include, for example, type, color, shape, size, location, distance from the second vehicle, and movement or speed data for the object.

In another embodiment, the processor 202 may include the overlapping area determination module 202B. The overlapping area determination module 202B is configured to determine an overlapping area between the first LOS of the first vehicle and the second LOS of the second vehicle based on the first LOS data and the second LOS data 112. The overlapping area may correspond to a visible area that may be commonly visible through the driver’s seat of both the first vehicle and the second vehicle when placed at a particular position one at a time. The overlapping area comprises one or more objects from the plurality of objects within the second LOS or the field of view of the second vehicle.

In an example, overlapping area determination module 202B is configured to analyze the plurality of objects based on the object data to identify the one or more objects that lie within the overlapping area. In an example, the overlapping area determination module 202B may determine an area or a level of each of the plurality of objects that may lies within the overlapping area. For example, the overlapping area determination module 202B may identify object(s) from the plurality of objects that completely lie within the overlapping area, i.e., the object(s) having their entire area within the overlapping area. The overlapping area determination module 202B may also identify object(s) from the plurality of objects that partially lie within the overlapping area, i.e., the object(s) having a part of their entire area within the overlapping area while the other part may be in the second LOS. In this regard, the overlapping area determination module 202B also determine an extent of area of the object(s) partially lying in the second LOS, i.e., an amount of an area of the object(s) lying in the overlapping area vs an amount of the area of the object(s) lying outside of the overlapping area, such as in the second LOS.

In yet another embodiment, the processor 202 may include the driving data generation module 202C. In an example, the driving data generation module 202C is configured to generate the driving data 114 for the second vehicle based on the one or more objects in the overlapping area. In this regard, the objects that may lie within both the first LOS as well as the second LOS may be used for generating the driving data 114. For example, as the user is habitual to the first LOS, the one or more objects lying within the first LOS may be easy to identify and react to for the user. Subsequently, the objects that do not lie within the first LOS and the second LOS, are avoided for generating the driving data 114. For example, the driving data 114 may include, but is not limited to, navigation instructions for operating or navigating the second vehicle. The navigation instructions may include turn-by-turn instructions for moving the second vehicle reliably and safely such that the user may learn to operate the second vehicle proficiently.

In an example, while generating the driving data 114, the one or more objects from the plurality of objects lying in the overlapping area may be used. In this regard, the driving data generation module 202C is configured to utilize object data associated with at least one of the one or more objects in the overlapping area to generate the driving data 114. In an example, the driving data generation module 202C may be configured to identify an object from the one of more objects in the second LOS lying completely within the overlapping area based on the object data. Further, the driving data generation module 202C may be configured to generate the driving data for the second vehicle based on the identified object that lies completely in the overlapping area.

In certain cases, the driving data 114 may also include feedback or guidelines. For example, the feedback or guidelines may include variations in design, speed, operation, braking, etc. between the first vehicle and the second vehicle.

In an example, the user may be transitioning from an SUV to a racing car. In such a case, an LOS of the SUV may vary significantly from an LOS of the racing car. In such a case, object(s) that may partially lie in the overlapping area may be used to generate the driving data 114. In this regard, the driving data 114 for the second vehicle or the racing car is generated based on object(s) that may be slightly present in the second LOS.

In an example, the processor 202 may utilize an artificial intelligence (AI) model to generate the overlapping area, identify the one or more objects from the plurality of objects lying in the overlap area, and generate the driving data 114 based on the one or more objects. The AI model may minimize the adaptation process by ensuring no accidents and minimizes the learning curve period. For example, the AI model may be trained to compare the first LOS and the second LOS to determine the overlapping area and determine a level of overlap of an object between the overlapping area and the second LOS to check if the object completely or partially lies in the overlapping area. Further, the driving data 114 is generated based on the one or more objects that lie within the overlapping area.

The AI model may utilize the historical driving data 110 to determine the first LOS data of the first vehicle. The AI model may compare the first LOS of the first vehicle with the second LOS of the second vehicle for turn-to-turn navigation. For example, the AI model may perform the comparison between the first LOS and the second LOS to determine the overlapping area and detect objects in the overlapping area. In an example, the AI model may generate the driving data 114 based on lanes that may have highest number of objects from the one or more object that lie in the overlapping area between the first LOS and the second LOS as such lanes may enable safe driving during the vehicle transition to the second vehicle.

In certain cases, the input module 202A may also obtain object preference data associated with the user. In an example, the user is associated with the first vehicle and the second vehicle. Further, the object preference data associated with the user may indicate a manner in which the driving data 114 is to be generated and/or provided to the user. In an example, the object preference data may indicate a type of object (e.g. buildings) to be used for generating the driving data 114. In another example, the object preference data may indicate a color of objects (e.g. red or yellow) to be used for generating the driving data 114.

In such a case, the driving data generation module 202C is configured to generate the driving data 114 for the second vehicle based at least in part on the object preference data. For example, the identified one or more objects lying in the overlapping area may be further analyzed based on the object preference data. In an example, a determination may be made if an object from the identified one or more objects satisfy the preference(s) of the user indicated by the object preference data. If the object satisfies the preference(s) of the user, then such object may be used to generate the driving data 114. Alternatively, if the object does not satisfy the preference(s) of the user then such object may not be used to generate the driving data 114 and other objects from the identified one or more objects may be used/ analyzed.

In an embodiment, the user may provide a list of preferences in a desired order. In an example, none or only a few objects from the one or more objects satisfy a first or most highly rated preference of the user. In such a case, other less rated or second preference of the user may be used to identify more objects from the one or more objects for generating the driving data 114.

Further, if none of the identified one or more objects satisfy the preference(s) of the user, then driving data 114 may be generated based on any of the one or more objects.

In an example, the driving data 114 may then be fed to the routing module 202d. The routing module 202d may be configured to generate user readable or user-understandable navigation instructions, such as routing messages, notifications, warning messages, etc., based on the driving data 114. The routing module 202d may send or push the routing messages to user equipment, such as user equipment on-board the second vehicle to enable routing of the second vehicle in reliable manner while ensuring safety of the user driving the second vehicle. The routing module 202d may also send or push routing messages to other user equipment associated with the second vehicle.

In accordance with an example embodiment, the processor 202 may be configured to generate a simulation environment based on the overlapping area and the second LOS data 112. For example, the simulation environment or driving simulator is a virtual environment that simulates real-world driving scenarios for the purpose of training and practice. The simulation environment may replicate the experience of driving the second vehicle in a controlled and safe setting, allowing the user to learn and improve their driving skills without the risks associated with on-road practice.

In an example, a display screen or multiple screens provide a realistic view of the simulated driving environment. High-resolution graphics and detailed scenery recreate roads, traffic, weather conditions, and other elements encountered during actual driving are generated within the simulation environment based on the object data. Subsequently, the simulation environment is generated based on the overlapping area and the second LOS data 112, such that one or more objects from the plurality of objects may be shown to lie within the overlapping area. Further, the LOS of a simulation of the second vehicle in the simulation environment is set based on actual dimensions of windshield, windows, and mirrors of the second vehicle to which the user wants to transition.

Thereafter, the processor 202 is configured to provide the driving data 114 for controlling navigation of a simulation of the second vehicle within the simulation environment. For example, the driving data 114 may include navigation instructions for guiding the user for operating the simulation of the second vehicle in the simulation environment. The user may learn to follow the driving instructions provided as part of the driving data 114.

In an example, the driving data 114 may be dynamically adjusted to provide real-time feedback on driving performance, including aspects such as speed, lane position, braking, and adherence to traffic rules. In some cases, the driving data 114 may be dynamically adjusted when user is unable to follow the driving data 114 to provide more insights, feedback, detailed instruction, tips, etc.

In an example, the overlapping area may continually change as the second LOS changes. Subsequently, different objects may be identified to lie in the overlapping area at different time instances, considering that the second vehicle is moving. Subsequently, the driving data may keep getting updated based on the changing objects and the overlapping area.

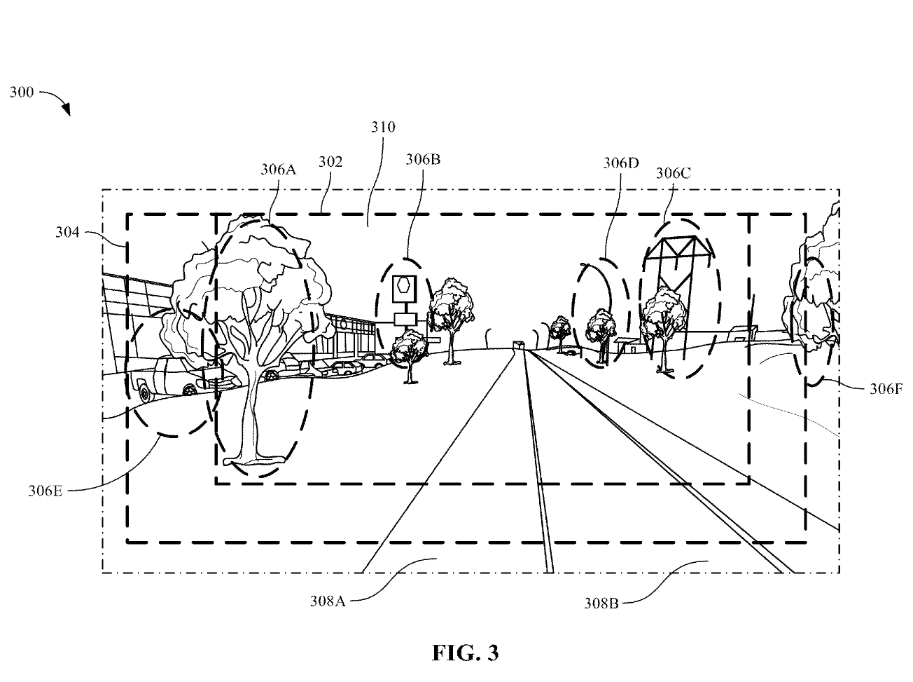

FIG. 3 illustrates an example geographic area 300, in accordance with an example embodiment. The geographic area 300 includes objects 306A, 306B, 306C, and 306D, 306E and 306F (collectively referred to as a plurality of objects 306 or objects 306). The geographic area 300 may also include other physical structures (not shown), such as bridges, flyovers, lampposts, streetlights, trees, billboards, dividers, buildings, etc. Moreover, the geographic area 300 may include a road segment for driving having one or more lanes (depicted as lanes 308a and 308b, and collectively referred to as lanes 308).

To this end, the system 102 is configured to obtain the historical driving data 110 comprising first LOS data associated with a first vehicle. The system 102 is also configured to determine the second LOS data 112 associated with a second vehicle. The first LOS data is associated with a first LOS 302 of the first vehicle while the second LOS data 112 is associated with a second LOS 304 of the second vehicle. The first LOS 302 and the second LOS 304 may indicate viewing ability through windshield, mirrors and/or windows of the first vehicle and the second vehicle, respectively.

According to the present example, the first LOS 302 is smaller than the second LOS 304. The first vehicle may be smaller than the second vehicle. For example, the first vehicle is a currently used vehicle associated with a user or a recurrently used vehicle of the user. The second vehicle is a new vehicle associated with the user. The user may be transitioning from a smaller first vehicle (such as a hatchback, a sedan) to a bigger second vehicle (such as a SUV or a truck). It may be noted that such examples of the vehicles are only exemplary and should not be construed as a limitation.

The system 102 is configured to determine object data associated with the second LOS 304 based on the second LOS data. The object data is associated with the objects 306 within the field of view or the second LOS 304 of the second vehicle. In an example, the object data corresponding to an object, say the object 306a may include, location of the object 306a, relative distance between the object 306a and the second vehicle, a type (i.e., tree, vehicle, billboard road sign, traffic sign, etc.) of the object 306a, a speed of the object (if the object is moving such as, a vehicle, a pedestrian, a cyclist, etc.), a color of the object 306a, and a dimensions of the object 306a.

Further, the system 102 is configured to determine an overlapping area 310 between the first LOS 302 and the second LOS 304. The overlapping area 310 is included within a boundary of the first LOS 302 as well as a boundary of the second LOS 304. Since the overlapping area is a part of the second LOS that is, such as completely or partially, mapped to the first LOS, the user of the second vehicle is able to drive the second vehicle reliably using the driving data 114 generated based on the overlapping area.

To this end, the system 102 identifies the one or more objects from the plurality of objects 306 that may lie within the overlapping area 310. In an example, an overlapping score for each of the objects 306 may be determined based on an area of an object lying within the overlapping area 310 and an area of the object lying outside of the overlapping area 310. For example, the overlapping score may be generated on a scale of 0 to 1. Moreover, an object that completely lies within the overlapping area 310 may have an overlapping score of 1, while an object that lies 90% within the overlapping area may have an overlapping score of 0.9. In this regard, an object having the overlapping score greater than a threshold, say 0.7, may be identified as a part of the one or more objects within the overlapping area 310. Based on the identified one or more objects within the overlapping area 310, the driving data 114 is generated. These one or more objects may be easily identifiable by the user as the user is habitual to the first LOS.

For example, the objects 306B, 306C and 306D completely lie within the overlapping area 310, the object 306A may be partially present in the overlapping area, and the objects 306E and 306F may be absent from the overlapping area 310. For example, as the objects 306A, 306B, 306C and 306D lie within the overlapping area 310, they may be used to generate the driving data 114.

In an embodiment, the system 102 is configured to obtain map data associated with the second LOS 304. The map data may be obtained from the map database 118. The map data may include digital information that represents geographical features, landmarks, roads, and other relevant details associated with the geographic area 300. In an example, the map data may include, but is not limited to, geographical features, point of interests, traffic information, addresses and geocodes, landmarks and buildings, topography and terrain, and navigation attributes.

Further, the system 102 is configured to determine lane view data associated with one or more lanes, i.e., lanes 308 within the second LOS 304 of the second vehicle based on the second LOS data 112 and the map data. For example, at least one object from the plurality of objects 306 may lie on one of the one or more lanes 308. In particular, the system 102 is configured to associate each of the objects 306 with its corresponding lane from the lanes 308. For example, based on location, orientation, heading, etc. of each of the objects 306, they may be associated with one of the lanes 308. For example, the objects 306A, 306B and 306E are associated with the lane 308A, while the objects 306C, 306D and 306F are associated with the lane 308B. Moreover, the lane view data may be determined based on the one or more objects lying in the overlapping area. The lane view data may include information about objects associated with a lane, say 308A, as well as whether the objects of the lane 308A lie in the overlapping area 310. For example, the lane view data associated with the lane 308A may indicate that the objects 306A and 306B lie in the overlapping area 310 whereas the object 306E is outside of the overlapping area 310.

Further, the system 102 is configured to identify a lane from the one or more lanes 308 lying within the overlapping area 310. Thereafter, the identified one or more objects within the overlapping area 310 may be analyzed to check or ascertain a lane to which each of them is associated. In an example, an object from the one or more objects may be associated with a lane from the lanes 308 based on its location, spatial position, geocoordinates, etc. For example, a lane having maximum number of objects lying in the overlapping area 310 may be used.

Further, the system 102 is configured to generate the driving data 114 for the second vehicle based on the identified lane. In an example, the driving data 114 may include navigation instructions based on the overlapping area 310 and the one or more objects in the overlapping area 310. The driving data 114 may also include, but is not limited to, alerts, guidelines about operating the second vehicle, input (such as, speed, acceleration, when to operate turn lights or other indicators), etc. In an example, the driving data 114 may be stored in a database, such as the map database 118 for generating navigation instructions for the second vehicle at a later stage.

It may be noted that once the user starts to drive the second vehicle, the field of view or the second LOS 304 of the second vehicle may keep on changing. Subsequently, the system 102 may be configured to generate the overlapping area for different locations and/or positions of the second vehicle and different second LOS in real-time. The identified objects and the overlapping area 310 scores may be used to generate the driving data 114 in real-time. To this end, the system 102 may be configured to provide turn-by-turn navigation instructions to the user based on the objects lying in the overlapping area 310 as well as the second LOS 304 of the second vehicle.

In an example, the system 102 is configured to generate the driving data 114 based on the objects 306A and 306B of the lane 308A that may lie within the overlapping area 310. For example, the driving data 114 may include the instructions “take a left from the billboard 306B to park the car”, or “keep driving straight for 2 miles from the tree 306A in the lane 308A”.

For example, the system 102 may identify a lane from the lanes 308 having a higher number of objects lying in the overlapping area. For example, the lane 308A may have a higher number of objects lying in the overlapping area. Subsequently, the driving data 114 may include instructions to move the second vehicle into the lane 308A. For example, if the second vehicle was initially in the lane 308B, then the driving data 114 may include the instruction “take slight left to move closer to the billboard and stay in the lane”.

In an example, the object preference data associated with the user of the second vehicle is also used for generating the driving data 114. In this regard, the driving data 114 may be generated based on one or more preferences described by the user with regard to object. For example, the user may provide a first preference as ‘yellow-colored objects’ and a second preference as ‘buildings’. In such a case, yellow objects from the objects 306 may be used to generate the driving data 114, for example, the instruction “drive straight for 2 miles from yellow gas station billboard”. For example, the yellow object is determined from the one or more objects lying within the overlapping area 310. Further, if no yellow object is present in the second LOS 304 and/or the overlapping area, the system 102 may identify objects corresponding to building from the one or more objects lying in the overlapping area 310. In this manner, the objects that are used to generate the driving data 114 are based on user preferences so that it may be easily identified by the user, and they may perform necessary operations effectively.

In an embodiment, the system 102 is configured to determine updated driving characteristic data of the user based on the historical driving data 110 and the second LOS data 112. In an example, the historical driving data 110 may include, but is not limited to, vehicle characteristic data (such as make, model, year of manufacturing, engine specifications, safety features, body type, yaw rate, etc.), sensor data (such as, acceleration, rotational speed, angular speed, location data, etc.), driving characteristic data (such as, behavior and habits while operating the first vehicle) associated with the user of the first vehicle, and historical adaptation data (such as adaptation period and adaptation behavior during a previous vehicle transition) associated with the user.

Further, based on the historical driving data 110 and the second LOS data 112, the updated driving characteristic data of the user may be determined. For example, the updated driving characteristic data of the user may be determined or predicted using an AI model. The updated driving characteristic data may indicate behaviors, habits, and traits that may likely be exhibited by the user while operating the second vehicle based on past trends. The updated driving characteristic data of the user may include, but is not limited to, speeding tendency, braking, aggressiveness, defensive driving, adaptability, awareness, driving skill level, and compliance with traffic laws.

The system 102 may be configured to generate the driving data 114 for the second vehicle based on the updated driving characteristics of the user. For example, if the skill level of the user is not advanced and/or the user is not compliant with traffic laws, then the driving data 114 may include driving instructions, such as “do not switch lanes frequently”, “do not switch lanes without giving turn indication”, “your new vehicle has a higher center of gravity, do not make maneuver at a higher speed”, “do not use entertainment unit while driving”, etc.

In another embodiment, the system 102 is configured to provide the driving data 114 to the user in a simulation environment. For example, the user may be operating a simulation of the second vehicle in the simulation environment. Further, to learn to maneuver the second vehicle properly, the driving data 114 may be provided to the user to maneuver the simulation of the second vehicle in the simulation environment.

In yet another embodiment, the system 102 is configured to determine a compatibility score for the user based on the historical driving data 110 associated with the first vehicle and the second LOS data 112. For example, the compatibility score may indicate how well-suited the second vehicle is to the needs, preferences, and driving characteristics of the user who operates it.

In an example, an AI model may be used to predict the compatibility score for the user and the second vehicle based on various factors, such as user’s experience, comfort, performance while driving the second vehicle, and characteristics of the second vehicle. In certain cases, the AI model may be used to determine the overlapping area 310 based on the first LOS data and the second LOS data 112, and generate driving data for the second vehicle. For example, the AI model is trained using supervised, unsupervised, or reinforcement learning techniques. Prior to training, training dataset may be preprocessed to ensure quality and relevance. Preprocessing steps may include data cleaning, normalization, transformation, and augmentation. This ensures the data is in an optimal format for training the AI model. Further, the AI model may be based on various architectures such as convolutional neural networks (CNNs), recurrent neural networks (RNNs), transformers, or a combination thereof.

In an example, the AI model may include an input layer that receives input data, one or more hidden layers, and an output layer. The input data may be in the form of text, images, numerical values, or other formats. The one or more hidden layers may process the input data using various mathematical functions. These layers may include fully connected layers, convolutional layers, pooling layers, and so forth. Further, the output layer produces a final result that may be a determination or prediction of the overlapping area 310, the confidence score, and/or the driving data. In an example, the AI model is trained using a dataset that includes historical driving data and new driving data for one or more training vehicles and/or first LOS and second LOS of various vehicles to learn to calibrate driving data. During training, model parameters of the AI model are adjusted to minimize the error between the predicted output and the actual output. Techniques such as backpropagation and gradient descent are employed to optimize the model parameters. Post-training, the AI model may be evaluated using a separate validation dataset to ensure accuracy and generalizability. Metrics such as accuracy, precision, recall, F1-score, and others are used to assess performance. Cross-validation techniques may also be applied to further validate the AI model. Once trained and validated, the AI model is deployed in an operational environment. The model may be integrated into a software application, embedded in hardware, or accessed via an API. Continuous monitoring and updating of the model are conducted to maintain performance over time.

Based on the compatibility score, the system 102 may be configured to generate a recommendation of one or more vehicles associated with one or more vehicle types. For example, if a comparability score for the user of a vehicle type of the second vehicle is high, then the one or more vehicles may be relating to the vehicle type of the second vehicle. In an example, if skill level of the user is high for driving the second vehicle, such as an SUV, then high-performance SUVs may be recommended to enhance experience of the user. Alternatively, if skill level of the user is not good for driving the second vehicle, such as an SUV, then a basic version of SUVs or compact SUVs may be recommended to the user.

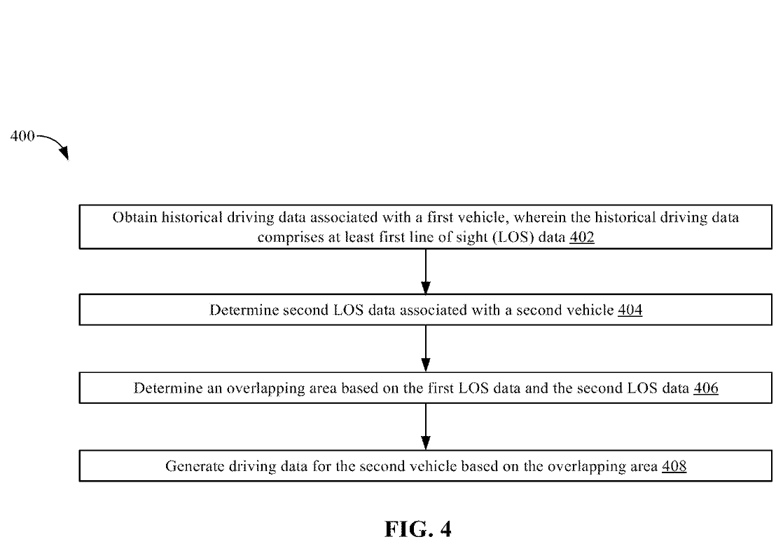

FIG. 4 illustrates an example method 400 for generating the driving data 114 for navigation assistance during vehicle transition, in accordance with an example embodiment. Additional, fewer, or different blocks or steps may be provided.

At 402, historical driving data 110 is obtained. In an example, the processor 202 is configured to obtain the historical driving data 110 from the database 106. The historical driving data 110 comprises the first LOS data. The first LOS data may include information associated with the first LOS 302 of the first vehicle. For example, the historical driving data 110 further comprises vehicle characteristic data, sensor data, driving characteristic data associated with a user of the first vehicle, and historical adaptation data associated with the user. Moreover, the historical driving data 110 further comprises seat adjustment data, height data associated with a user, steering adjustment data, sideview mirror adjustment data, and rear view mirror adjustment data.

At 404, the second LOS data 112 associated with a second vehicle is determined. In an example, the processor 202 is configured to determine the second LOS data 112. The second LOS data 112 may include information associated with the second LOS 304 of the second vehicle. Moreover, the second LOS may include a plurality of objects 306 lying in the field of view or visible from the driver’s seat of the second vehicle. Subsequently, the second LOS data may also include object data associated with the plurality of objects 306 in the field of view of the second vehicle or the second LOS 304.

At 406, an overlapping area associated with the second vehicle is determined. In an example, the processor 202 or the overlapping area determination module 202B is configured to determine the overlapping area 310 based on a comparison between the first LOS 302 and the second LOS 304. A common area lying in both the first LOS 302 and the second LOS 304 may be identified as the overlapping area 310. In an example, one or more objects from the plurality of objects 306 may lie within the overlapping area 310.

At 408, driving data 114 is generated for the second vehicle based on the one or more objects in the overlapping area 310. In an example, the processor 202 or the driving data generation module 202C is configured to generate the driving data 114. For example, the driving data 114 may include navigation instructions based on the one or more objects present in the overlapping area 310.

Accordingly, blocks of the method 400 support combinations of means for performing the specified functions and combinations of operations for performing the specified functions. It will also be understood that one or more blocks of the method 400, and combinations of blocks in the method 400 can be implemented by special purpose hardware-based computer systems which perform the specified functions, or combinations of special purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the method 400 disclosed herein, the end result generated by the system 102 is a tangible updated driving data for navigation assistance during vehicle transition, wherein such updated driving data based on objects present in field of view may be used to help the user to transition to the second vehicle from the first vehicle and ensure safety and reliability while operating the second vehicle.

Returning to FIG. 1, the communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In an example, the system 102 may be embodied as a cloud-based service, a cloud-based application, a cloud-based platform, a remote server-based service, a remote server-based application, a remote server-based platform, or a virtual computing system. In another example, the system 102 may be an OEM (Original Equipment Manufacturer) cloud. The OEM cloud may be configured to anonymize any data received by the system 102, before using the data for further processing, such as before sending the data to the database 106. In an example, anonymization of the data may be done by the mapping platform 108.

The mapping platform 108 may comprise suitable logic, circuitry, and interfaces that may be configured to store and process information. The mapping platform 108 may also be configured to store and update data within the map database 118. The mapping platform 108 may include or may be configured to perform techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as, chips) that includes materials, components and/or wires on a structural assembly (such as, a baseboard).

In some example embodiments, the mapping platform 108 may include the processing server 116 for carrying out the processing functions associated with the mapping platform 108 and the map database 118 for storing map data and other information. In an example, the map database 118 may store information relating to geographic areas. In an embodiment, the processing server 116 may comprise one or more processors configured to process requests received from the system 102. The processors may fetch data from the map database 118 and transmit the same to the system 102 in a format suitable for use by the system 102. The historical driving data 110 and the second LOS data 112 may be collected from any sensor or database that may inform the mapping platform 108 or the map database 118 of features of the first vehicle and the second vehicle. For example, motion sensors, inertia sensors, image capture sensors, proximity sensors, LIDAR (light detection and ranging) sensors, and ultrasonic sensors may be used to collect the historical driving data 110 and the second LOS data 112. In some example embodiments, as disclosed in conjunction with the various embodiments disclosed herein, the system 102 may be used to process the historical driving data 110 and the second LOS data 112 for determining the overlapping area 310 and identify objects in the overlapping area 310 for generating the driving data 114.

In some example embodiments, the map database 118 may also be configured to receive, store, and transmit other sensor data and probe data including positional, speed, and temporal data received from vehicles, such as the first vehicle. In accordance with an embodiment, the probe data may include, but is not limited to, real time speed (or individual probe speed), incident data, geolocation data, timestamp data, and historical pattern data.

The map database 118 may further be configured to store object-related data and topology and geometry-related data for a route network and/or road network as map data. The map data may also include cartographic data, routing data, and maneuvering data.

For example, the data stored in the map database 118 may be compiled (such as into a platform specification format (PSF)) to organize and/or processed for generating the driving data 114. The driving data 114 may include navigation instructions based on the objects. The compilation to produce the end user databases may be performed by a party or entity separate from the map developer. For example, a customer of the map developer, such as a navigation device developer or other end user device developer, may perform compilation on a received database in a delivery format to produce one or more compiled navigation databases.

The various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer executable instructions; and
one or more processors configured to execute the instructions to:
obtain historical driving data associated with a first vehicle, wherein the historical driving data comprises at least first line of sight (LOS) data;
determine second LOS data associated with a second LOS of a second vehicle, wherein the second LOS comprises a plurality of objects;
determine an overlapping area based on the first LOS data and the second LOS data, wherein the overlapping area comprises one or more objects from the plurality of objects; and
generate driving data for the second vehicle based on the one or more objects in the overlapping area.

2. The system of claim 1, wherein the second LOS data comprises object data associated with the plurality of objects within the second LOS of the second vehicle, and wherein the one or more processors are further configured to execute the instructions to:
identify an object from the one of more objects in the second LOS lying completely within the overlapping area, based on the object data; and
generate the driving data for the second vehicle based on the identified object.

3. The system of claim 1, wherein the one or more processors are further configured to execute the instructions to:
obtain object preference data associated with a user, wherein the user is associated with the first vehicle and the second vehicle; and
generate the driving data for the second vehicle based at least in part on the object preference data.

4. The system of claim 1, wherein the one or more processors are further configured to execute the instructions to:
obtain map data associated with the second LOS;
determine lane view data associated with one or more lanes within the second LOS based on the second LOS data and the map data;
identify a lane from the one or more lanes lying within the overlapping area; and
generate the driving data for the second vehicle based on the identified lane.

5. The system of claim 1, wherein the first vehicle is a recurrently used vehicle associated with a user and the second vehicle is a new vehicle associated with the user.

6. The system of claim 1, wherein the historical driving data associated with the first vehicle further includes at least one of: vehicle characteristic data, sensor data, driving characteristic data associated with a user of the first vehicle, and historical adaptation data associated with the user.

7. The system of claim 6, wherein the one or more processors are further configured to execute the instructions to:
determine updated driving characteristic data of the user based on the historical driving data and the second LOS data; and
generate the driving data for the second vehicle based on the updated driving characteristics of the user.

8. The system of claim 6, wherein the one or more processors are further configured to execute the instructions to:
determine a compatibility score for the user based on the historical driving data associated with the first vehicle and the second LOS data; and
generate a recommendation of one or more vehicles associated with one or more vehicle types based on the compatibility score.

9. The system of claim 1, wherein the historical driving data comprises at least one of: seat adjustment data, height data associated with a user, steering adjustment data, sideview mirror adjustment data, and rear view mirror adjustment data.

10. The system of claim 1, wherein the one or more processors are further configured to execute the instructions to:
generate a simulation environment based on the overlapping area and the second LOS data; and
provide the driving data for controlling navigation of a simulation of the second vehicle within the simulation environment.

11. A method comprising:
obtaining historical driving data associated with a first vehicle, wherein the historical driving data comprises at least first line of sight (LOS) data;
determining second LOS data associated with a second LOS of a second vehicle, wherein the second LOS comprises a plurality of objects;
determining an overlapping area based on the first LOS data and the second LOS data, wherein the overlapping area comprises one or more objects from the plurality of objects; and
generating driving data for the second vehicle based on the one or more objects in the overlapping area.

12. The method of claim 11, wherein the second LOS data comprises object data associated with the plurality of objects within the second LOS of the second vehicle, and wherein the method further comprises:
identifying an object from the one of more objects in the second LOS lying completely within the overlapping area, based on the object data; and
generating the driving data for the second vehicle based on the identified object.

13. The method of claim 11, further comprising:
obtaining object preference data associated with a user, wherein the user is associated with the first vehicle and the second vehicle; and
generating the driving data for the second vehicle based at least in part on the object preference data.

14. The method of claim 11, further comprising:
obtaining map data associated with the second LOS;
determining lane view data associated with one or more lanes within the second LOS based on the second LOS data and the map data;
identifying a lane from the one or more lanes lying within the overlapping area; and
generating the driving data for the second vehicle based on the identified lane.

15. The method of claim 11, wherein the historical driving data associated with the first vehicle further includes at least one of: vehicle characteristics, sensor data, driving characteristic data associated with a user of the first vehicle, and historical adaptation period associated with the user.

16. The method of claim 15, further comprising:
determining updated driving characteristic data of the user based on the historical driving data and the second LOS data; and
generating the driving data for the second vehicle based on the updated driving characteristics of the user.

17. The method of claim 15, further comprising:
determining a compatibility score for the user based on the historical driving data associated with the first vehicle and the second LOS data; and
generating a recommendation of one or more vehicles associated with one or more vehicle type based on the compatibility score.

18. The method of claim 11, wherein the historical driving data comprises at least one of: seat adjustment data, height data associated with a driver, steering adjustment data, outer rear view mirror adjustment data, and inner rear view mirror adjustment data.

19. The method of claim 11, further comprising:
generating a simulation environment based on the overlapping area and the second LOS data; and
providing the driving data for controlling navigation of a simulation of the second vehicle within the simulation environment.

20. A computer programmable product comprising a non-transitory computer readable medium having stored thereon computer executable instructions, which when executed by one or more processors, cause the one or more processors to carry out operations comprising:
obtaining historical driving data associated with a first vehicle, wherein the historical driving data comprises at least first line of sight (LOS) data;
determining second LOS data associated with a second LOS of a second vehicle, wherein the second LOS comprises a plurality of objects;
determining an overlapping area based on the first LOS data and the second LOS data, wherein the overlapping area comprises one or more objects from the plurality of objects; and
generating driving data for the second vehicle based on the one or more objects in the overlapping area.
